(19) United States
(12) Patent Application Publication
(10) Pub. No.: US 2019/0310925 A1
(43) Pub. Date: Oct. 10, 2019

(54) INFORMATION PROCESSING SYSTEM AND PATH MANAGEMENT METHOD

(71) Applicant: HITACHI, LTD., Tokyo (JP)

(72) Inventors: Misato YOSHIDA, Tokyo (JP); Masakuni AGETSUMA, Tokyo (JP); Hideo SAITO, Tokyo (JP); Tsukasa SHIBAYAMA, Tokyo (JP); Akira YAMAMOTO, Tokyo (JP)

(73) Assignee: HITACHI, LTD., Tokyo (JP)

(21) Appl. No.: 16/298,619

(22) Filed: Mar. 11, 2019

(30) Foreign Application Priority Data
Apr. 6, 2018 (JP) 2018-074265

(51) Int. Cl. G06F 11/20; G06F 11/14; G06F 3/06

(52) U.S. Cl. CPC G06F 11/2094; G06F 11/2092; G06F 11/2076; G06F 3/067; G06F 3/0619; G06F 3/0635; G06F 3/065; G06F 11/1464

(57) ABSTRACT

A configuration of a redundancy group, which includes a control unit disposed in a storage node and set in an active mode for processing a request from a compute node and a control unit disposed in another storage node and set in a passive mode for taking over the process when a failure occurs in the control unit and the like, is inquired to the storage node, a plurality of paths from the compute node to a volume correlated with the redundancy group are set on the basis of the inquiry result, and the highest priority is set in a path connected to a storage node provided with the control unit of the active mode while the second highest priority is set in a path connected to a storage node provided with the control unit of the passive mode.

### BACKGROUND OF THE INVENTION

### 1. Field of the Invention

The present invention relates to an information processing system and a path management method, and for example, is suitable for an application to an information processing system including a plurality of storage nodes each provided with one or a plurality of software defined storages (SDSs).

### 2. Description of Related Art

In recent years, there has been active development of an SDS constructed by installing storage control software on a general-purpose server device (hereinafter, referred to as a storage node). Since the SDS does not require dedicated hardware and has high expansibility, demands for the SDS are also increasing. Also, there has been active development of an information processing system in which a plurality of storage nodes are combined with one another to configure one cluster and the cluster is provided to a higher-level device (hereinafter, referred to as a compute node) as one storage device.

In such an information processing system, it is general to set a plurality of paths (multipath) on the plurality of storage nodes by using multipath software for the purpose of fault tolerance. In such a case, among the plurality of paths, some paths are set as priority paths that are normally used and the remaining paths are set as redundant paths that are used when a failure occurs.

US 2016-0378342 discloses a multipath-related technology in which middleware of a compute node monitors a change in a storage structure, rescans a device when a change occurs in the storage structure, and re-sets a new storage structure in multipath software on the basis of the scanning result. Also, US 2016-0378342 discloses in which the shortest path is detected when such a change occurs and the detected shortest path is set as a priority path.

However, in US 2016-0378342, since the redundant path and the priority path are set on all the storage nodes, a path with a slow processing speed is temporarily used immediately after node failure of a priority path destination. Therefore, there is a problem that response performance of the storage node from the viewpoint of the compute node is reduced or a problem that it is not possible to set the redundant path on all the storage nodes due to a resource limitation of an operating system (OS) or multipath software.

Furthermore, when a communication standard used in a path is an internet SCSI (small computer system interface) (iSCSI), a session is always performed and unnecessary packets continuously flow through an unused redundant path. Therefore, when the redundant path and the priority path are set on all the storage nodes as disclosed in US 2016-0378342, there is a problem that a corresponding network band is wasted as an entire multipath.

### SUMMARY OF THE INVENTION

The invention is devised in view of the foregoing circumstances and proposes an information processing system and a path management method, by which it is possible to set multipath with high fault tolerance.

In order to solve the foregoing problems, according to the invention, there is provided an information processing system including: one or a plurality of storage nodes each provided with one or a plurality of storage devices; and one or a plurality of compute nodes that read and write data from and to the storage nodes, wherein each storage node is provided with one or a plurality of control units, a plurality of control units provided in the different storage nodes are managed as redundancy groups and one or a plurality of volumes, to which a storage area is provided from the storage device, are correlated with the redundancy groups, some of the control units constituting the redundancy group are set in an active mode in which the request from the compute node is received and remaining control units constituting the redundancy group are set in a passive mode in which the request is not received, the control unit set in the active mode reads and writes data from and to the volume in accordance with the request from the compute node, which targets the volume correlated with the redundancy group including the control unit, and the control unit set in the passive mode is switched to the active mode when the control unit set in the active mode is not able to process the request from the compute node, and the compute node inquires of the storage node about a configuration of each redundancy group, sets a plurality of paths from the compute node to the volume on the basis of the acquired configuration of each redundancy group, sets a priority in each path, transmits the request for the volume to a corresponding storage node by using an available path with a highest priority among the paths to the corresponding volume, and sets a highest priority in a path connected to the storage node provided with the control unit of the active mode, which constitutes the redundancy group correlated with the volume, while setting a second highest priority in a path connected to the storage node provided with the control unit of the passive mode, which constitutes the redundancy group, when setting the plurality of paths from the compute node to the volume.

Furthermore, according to the invention, there is provided a path management method performed in an information processing system, wherein the information processing system includes one or a plurality of storage nodes each provided with one or a plurality of storage devices and one or a plurality of compute nodes that read and write data from and to the storage nodes, each storage node is provided with one or a plurality of control units, a plurality of control units provided in the different storage nodes are managed as redundancy groups and one or a plurality of volumes, to which a storage area is provided from the storage device, are correlated with the redundancy groups, some of the control units constituting the redundancy group are set in an active mode in which the request from the compute node is received and remaining control units constituting the redundancy group are set in a passive mode in which the request is not received, the control unit set in the active mode reads and writes data from and to the volume in accordance with the request from the compute node, which targets the volume correlated with the redundancy group including the control unit, and the control unit set in the passive mode is switched to the active mode when the control unit set in the active mode is not able to process the request from the compute node, the path management method includes: a first step in which the compute node inquires of the storage node about a configuration of each redundancy group, sets a plurality of paths from the compute node to the volume on the basis of the acquired configuration of each redundancy group, and sets a priority in each path; and a second step in which the compute node transmits the request for the volume to a corresponding storage node by using an available path with a highest priority among the paths to the corresponding volume, and in the first step, the compute node sets a highest priority in a path connected to the storage node provided with the control unit of the active mode, which constitutes the redundancy group correlated with the volume, while setting a second highest priority in a path connected to the storage node provided with the control unit of the passive mode, which constitutes the redundancy group, when setting the plurality of paths from the compute node to the volume.

According to the information processing system and the path management method of the invention, even when a control unit set in an active mode is not able to process a request from a compute node and thus a control unit set in a passive mode up to that time is switched to the active mode, the control unit can access a volume via the shortest path at that time.

Accordingly, even when a failure occurs in the control unit set in the active mode, and the like and thus a path is switched to a path to the control unit set in the passive mode up to that time, it is possible to effectively prevent response performance from the viewpoint of the compute node from being reduced in advance.

According to the invention, it is possible to realize an information processing system and a path management method, by which it is possible to set multipath with high fault tolerance.

### BRIEF DESCRIPTION OF THE DRAWINGS

FIG. 1 is a block diagram illustrating an overall configuration of an information processing system according to the present embodiment;

FIG. 2 is a block diagram illustrating a schematic configuration of a compute node;

FIG. 3 is a block diagram illustrating a schematic configuration of a storage node;

FIG. 4 is a block diagram illustrating a logical configuration of a memory of the compute node;

FIG. 5 is a block diagram illustrating a logical configuration of a memory of the storage node;

FIG. 6 is a table illustrating a configuration example of a system configuration information table;

FIG. 7 is a table illustrating a configuration example of a multipath configuration information table;

FIG. 8 is a table illustrating an update example of the multipath configuration information table;

FIG. 9 is a block diagram for explaining a path management function according to the present embodiment;

FIG. 10 is a block diagram for explaining another path management function according to the present embodiment;

FIG. 11 is a block diagram for explaining still another path management function according to the present embodiment;

FIG. 12 is a flowchart illustrating a processing procedure of a multipath setting process;

FIG. 13 is a flowchart illustrating a processing procedure of a system configuration information transmission process;

FIG. 14 is a flowchart illustrating a processing procedure of a multipath configuration information registration process;

FIG. 15 is a flowchart illustrating a processing procedure of a path priority setting process;

FIG. 16 is a flowchart illustrating a processing procedure of an ALUA-use path priority setting process; and

FIG. 17 is a flowchart illustrating a processing procedure of an ALUA-non-use path priority setting process.

### DESCRIPTION OF EMBODIMENTS

Hereinafter, an embodiment of the invention will be described in detail with reference to the drawings.

The following description and drawings are examples for description of the invention and will be appropriately omitted and simplified in order to clarify the invention. Furthermore, all combinations of characteristics described in an embodiment are not essential to the solution means of the invention. The invention is not limited to the embodiment and all application examples satisfying the spirit of the invention are included in the technical range of the invention. In the invention, various additions, modifications, and the like can be made by a person skilled in the art within the scope of the invention. The invention can be embodied in various other forms. Unless specifically stated otherwise, each element may be multiple or single.

In the following description, various types of information will be described by expressions such as a “table”, a “chart”, a “list”, and a “queue”; however, various types of information may be expressed in other data structures. In order to represent that information does not depend on a data structure, a “XX table”, a “XX list”, and the like may be referred to as “XX information”. When the content of each information is described, expressions such as “identification information”, an “identifier”, a “name”, an “ID, and a “number” are used; however, these can be replaced with one another.

Furthermore, in the following description, when the same type of elements are described without distinction, reference numerals or common numbers in the reference numerals may be used, and when the same type of elements are distinctively described, reference numerals of the elements may be used or IDs allocated to the elements may be used instead of the reference numerals.

Furthermore, in the following description, there is a case where a process performed by executing a program is described; however, since the program is executed by at least one processor (for example, a CPU), and a prescribed process is appropriately performed using a storage resource (for example, a memory) and/or an interface device (for example, a communication port), the subject of the process may be the processor. Similarly, the subject of the process performed by executing the program may be a controller, a device, a system, a computer, a node, a storage system, a storage device, a server, a management computer, a client, or a host, which has a processor. The subject (for example, a processor) of the process performed by executing the program may also include a hardware circuit that performs a part or the whole of the process. For example, the subject of the process performed by executing the program may also include a hardware circuit that performs encryption and decryption, or compression and decompression. The processor operates as functional units for performing predetermined functions by operating according to the program. A device and a system including the processor are a device and a system including these functional units.

The program may be installed from a program source to a device such as a computer. The program source, for example, may be storage media readable by a program distribution server or a computer. When the program source is the program distribution server, the program distribution server may include a processor (for example, a CPU) and a storage source, and the storage source may store a distribution program and a program to be distributed. A processor of the program distribution server may execute the distribution program, and thus the processor of the program distribution server distributes the program to be distributed to other computers. Furthermore, in the following description, two or more programs may be implemented as one program or one program may be implemented as two or more programs.

### (1) CONFIGURATION OF INFORMATION PROCESSING SYSTEM ACCORDING TO PRESENT EMBODIMENT

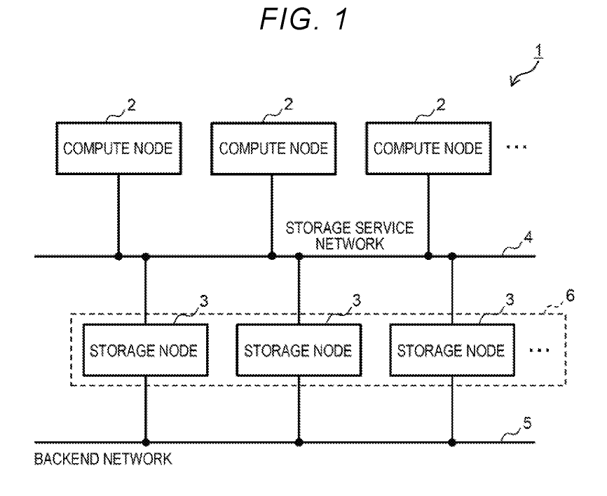

In FIG. 1, reference numeral 1 overall denotes an information processing system 1 according to the present embodiment. The information processing system 1 includes a plurality of compute nodes 2 and a plurality of storage nodes 3.

Each compute node 2 and each storage node 3, for example, are connected to each other via a storage service network 4 composed of a fibre channel, an Ethernet (registered trademark), an InfiniBand, a wireless local area network (LAN), and the like, and the storage nodes 3 are connected to one another via a backend network 5 composed of a LAN, an Ethernet (registered trademark), an InfiniBand, a wireless LAN, and the like.

The storage service network 4 and the backend network 5 may be configured by the same network, and each compute node 2 and each storage node 3 may be connected to a management network other than the storage service network 4 and the backend network 5.

The compute node 2 is a physical computer device having a function of reading and writing data from and to the storage node 3 via the storage service network 4 in accordance with a user operation or a request from an installed application program (hereinafter, referred to as an application). However, the compute node 2 may be a virtual computer device such as a virtual machine.

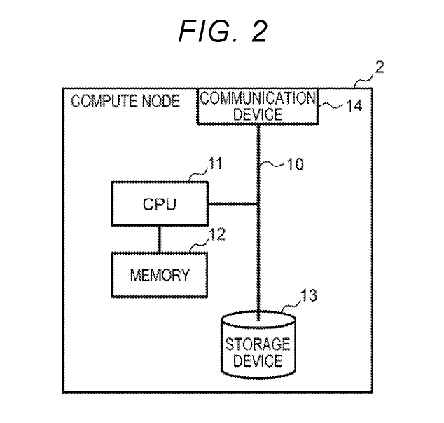

As illustrated in FIG. 2, the compute node 2 includes one or more central processing units (CPUs) 11, one or more storage devices 13, and one or more communication devices 14, which are connected to one another via an internal network 10, and one or more memories 12 connected to the CPUs 11.

The CPU 11 is a processor that controls an overall operation of the compute node 2. Furthermore, the memory 12 is composed of a volatile semiconductor memory such as a static random access memory (SRAM) and a dynamic RAM (DRAM) and a nonvolatile semiconductor memory, and is used as a work memory of the CPU 11.

The storage device 13 is composed of a large capacity nonvolatile storage device such as a hard disk drive (HDD), a solid state drive (SSD), and a storage class memory (SCM), and is used in order to retain various programs, control data and the like for a long period of time. When the program stored in the storage device 13 is loaded into the memory 12 when the compute node 2 is started or when necessary and the program loaded into the memory 12 is executed by the CPU 11, various processes as the entire compute node 2 as described below are performed.

The communication device 14 is an interface for allowing the compute node 2 to communicate with the storage node 3 via the storage service network 4, and for example, is composed of a fibre channel card, an Ethernet (registered trademark) card, an InfiniBand card, a wireless LAN card and the like. The communication device 14 performs protocol control at the time of communication with the storage node 3 via the storage service network 4.

The storage node 3 is a physical server device that provides the compute node 2 with a storage area for reading and writing data. However, the storage node 3 may be a virtual machine. Furthermore, the storage node 3 may be configured to stay at the same physical node as the compute node 2.

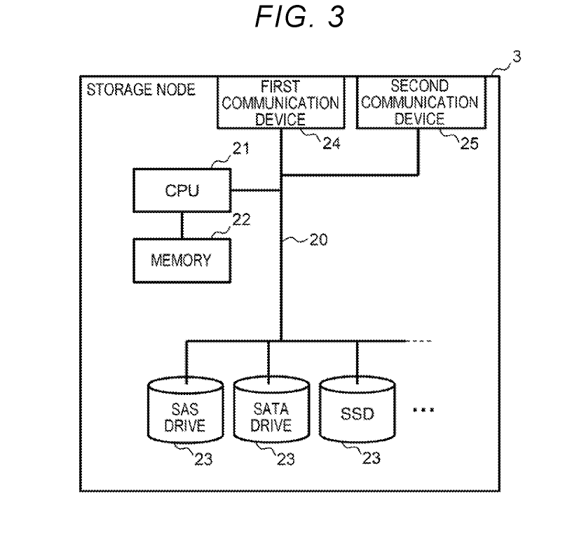

As illustrated in FIG. 3, the storage node 3 includes one or more CPUs 21, a plurality of storage devices 23, one or more first communication devices 24, and one or more second communication devices 25, which are connected to one another via an internal network 20, and one or more memories 22 connected to the CPUs 21. Among them, since the functions and configurations of the CPU 21 and the memory 22 are identical to those of corresponding parts (the CPU 11 and the memory 12) of the compute node 2, a description thereof will be omitted.

The storage device 23 is composed of a large capacity nonvolatile storage device such as an HDD, an SSD, and an SCM, and is connected to the second communication device via an interface such as a non-volatile memory express (NVMe), a serial attached SCSI (small computer system interface) (SAS), and a serial ATA (advanced technology attachment) (SATA).

Furthermore, the first communication device 24 is an interface for allowing the storage node to communicate with the compute node 2 via the storage service network 4, and the second communication device 25 is an interface for allowing the storage node 3 to communicate with other storage nodes 3 via the backend network 5. Since the first and second communication devices 24 and 25 have the same configurations as that of the communication device 14 of the compute node 2, a description thereof will be omitted.

In the case of the present embodiment, each storage node 3 is grouped into a group called a cluster 6 together with one or a plurality of other storage nodes 3 for the purpose of management as illustrated in FIG. 1. In the example of FIG. 1, a case where only one cluster 6 is set is illustrated; however, a plurality of clusters 6 may be provided in the information processing system 1. Each storage node 3 constituting one cluster 6 is recognized as one storage device from the compute node 2.

### (2) LOGICAL CONFIGURATION OF PRESENT INFORMATION PROCESSING SYSTEM

Next, a logical configuration of the present information processing system 1 will be described.

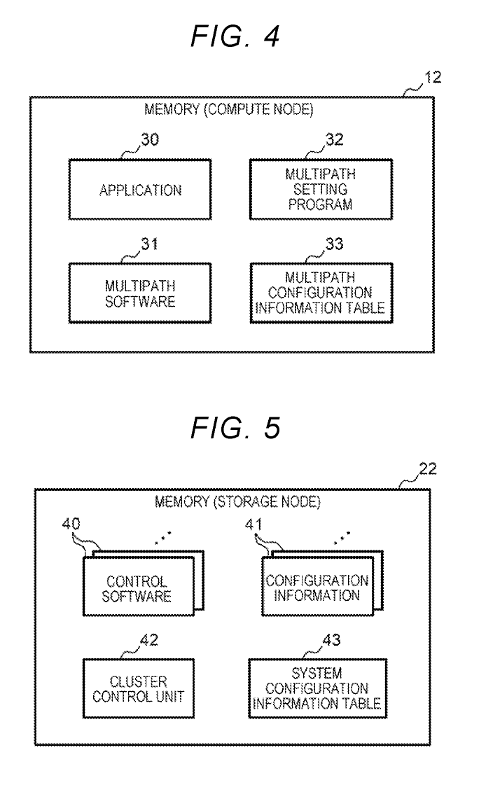

As illustrated in FIG. 4, the memory 12 of each compute node 2 stores an application 30, multipath software (hereinafter, referred to as a multipath software) 31, a multipath setting program 32, and a multipath configuration information table 33.

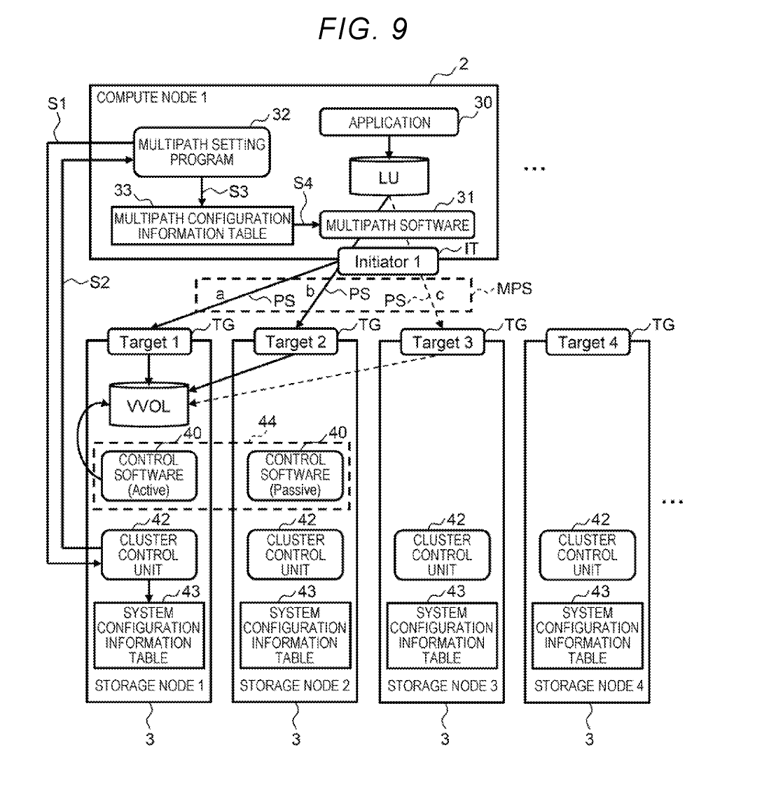

The application 30 is software that performs processing according to the work content of a user of the compute node 2. As illustrated in FIG. 9, in each storage node 3, one or a plurality of virtual logical volumes (hereinafter, referred to as virtual volumes) are generated and these virtual volumes are provided to the application 30 via a logical unit LU. In the case of reading and writing data from and to a desired virtual volume VVOL, the application 30 transmits, to the multipath software 31, an input/output (I/O) request that targets a logical unit LU correlated with the virtual volume VVOL (finally, a corresponding virtual volume VVOL).

The multipath software 31 is software having a function of setting a plurality of paths PS (multipath MPS) from each logical unit LU generated in its own compute node 2 to the virtual volume VVOL correlated with the logical unit LU, for each logical unit LU.

Actually, in each compute node 2, one or a plurality of initiators IT respectively associated with one or a plurality of logical units LU generated in the compute node 2 are defined. The initiator IT is correlated with any port (not illustrated) provided in each compute node 2. Furthermore, in each storage node 3, one or a plurality of targets TG, with which virtual volumes VVOL generated in the cluster 6 are associated, are defined. The target TG are each correlated with any port (not illustrated) provided in the storage node 3.

Then, the multipath software 31 sets a plurality of paths PS that connect the initiator IT, which is associated with the logical unit LU, to the targets TG, which are associated with the virtual volume VVOL corresponding to the logical unit LU, for each logical unit LU. In such a case, for each logical unit LU, the multipath software 31 sets a priority (hereinafter, referred to as a path priority) in the plurality of paths PS set for the logical unit LU.

Then, when an I/O request that targets a certain logical unit LU is received from the application 30, the multipath software 31 transmits the I/O request to a corresponding storage node by using a path PS with the highest path priority of paths PS available among the plurality of paths PS set for the virtual volume VVOL correlated with the logical unit LU.

In addition, in each target TG, it is possible to set an initiator IT capable of accessing the virtual volume VVOL via the target TG. In this way, the virtual volume VVOL accessible by the application 30 can be limited for each application 30.

Details of the multipath setting program 32 and the multipath configuration information table 33 will be described later.

On the other hand, as illustrated in FIG. 5, the memory 22 of each storage node 3 stores a plurality of control software (hereinafter, referred to as a control software) 40, a plurality of pieces of configuration information 41 generated in correlation with the control software 40, a cluster control unit 42, and a system configuration information table 43.

The control software 40 is software serving as a storage controller of a software defined storage (SDS). The control software 40 has a function of receiving the I/O request from the compute node 2 and reading and writing data from and to the corresponding storage device 23 (FIG. 3).

In the case of the present embodiment, as illustrated in FIG. 9, each control software 40 installed in the storage node is managed as one group (hereinafter, referred to as a redundancy group) 44 for redundancy together with one or a plurality types of control software 40 respectively installed in storage nodes 3 which are different from one another.

Then, one or a plurality of virtual volumes VVOL are correlated with each redundancy group 44, are provided to the compute nodes 2 as storage areas, where data is read and written, as described above, and are respectively correlated with any logical units LU of any compute node 2.

In such a case, the storage area in the virtual volume VVOL is divided into small areas (hereinafter, referred to as logical pages) with a predetermined size for the purpose of management. Furthermore, a storage area provided by each storage device 23 (FIG. 3) provided in the storage node 3 is divided into small areas (hereinafter, referred to as physical pages) with the same size as that of the logical page for the purpose of management. However, the logical page and the physical page may not have the same size.

Thus, in the case of reading and writing data from and to a desired virtual volume VVOL, the application 30 (FIG. 4) of the compute node 2 issues, to the multipath software 31 (FIG. 4), an I/O request that designates an identifier (logical unit number (LUN)) of the virtual volume VVOL of a read/write destination of the data, a logical page of a head of the read/write destination of the data in the virtual volume VVOL, and a data length of the data, and transmits the I/O request to a corresponding storage node 3 via a path PS to which the multipath software 31 corresponds.

FIG. 9 illustrates a case where the redundancy group 44 is configured by two types of control software 40 and the following description will be given on the assumption that the redundancy group 44 is composed of two types of control software 40; however, the redundancy group 44 may be composed of three or more types of control software 40.

In the redundancy group 44, at least one control software 40 is set in a state in which it is possible to receive an I/O request from the compute node 2 (a state of a current system, and hereinafter, referred to as an active mode), the I/O request targeting a virtual volume VVOL correlated with the redundancy group 44, and remaining control software 40 is set in a state in which the I/O request is not received (a state of a standby system, and hereinafter, referred to as a passive mode).

Accordingly, the redundancy group 44 including two types of control software 40 employs any one of a configuration in which both of the two types of control software 40 are set in the active mode (hereinafter, referred to as an active-active configuration) and a configuration in which one control software 40 is set in the active mode and the other control software 40 is set in the passive mode as its backup (hereinafter, referred to as an active-passive configuration).

In the redundancy group 44 employing the active-passive configuration, when a failure occurs in the control software 40 set in the active mode or the storage node 3 provided with the control software 40 or when the storage node 3 is removed from the cluster 6, the state of the control software 40 set in the passive mode up to that time is switched to the active mode (a failover function). In this way, when the control software 40 set in the active mode is no longer operational, an I/O process performed by the control software 40 can be taken over by the control software 40 set in the passive mode up to that time.

In order to perform such a failover function, the control software 40 belonging to the same redundancy group 44 always retains configuration information 41 having the same content. The configuration information 41 is information required when the control software 40 performs processing related to various functions such as a capacity virtualization function of virtualizing a storage area in a cluster and providing the virtualized storage area to a compute node, a hierarchical storage control function of moving more frequently accessed data to a storage area where a response speed is faster, a deduplication function of deleting duplicate data from stored data, a compression function of compressing and storing data, a snapshot function of retaining a state of data at a certain time point, and a remote copy function of copying data to a remote site synchronously or asynchronously for disaster countermeasures. For example, the configuration information 41 includes a mapping table in which a correspondence relation between the logical page of the virtual volume VVOL and the physical page of the storage device 23 (FIG. 3) is registered, and the like.

When the configuration information 41 of the control software 40 of the active mode constituting the redundancy group 44 is updated, a difference in the configuration information 41 before and after the update is transmitted to the other control software 40 constituting the redundancy group 44 as differential data, and the configuration information 41 retained by the control software 40 is updated by the other control software 40 on the basis of the differential data. In this way, the configuration information 41 retained by each control software 40 constituting the redundancy group 44 is always maintained in a synchronized state.

As described above, since the two types of control software constituting the redundancy group 44 always retains the configuration information 41 having the same content, even when a failure occurs in the control software 40 set in the active mode or the storage node 3 provided with the control software 40 or even when the storage node 3 is removed, a process performed by the control software 40 up to that time can be immediately taken over by the other control software 40 in the redundancy group 44 to which the control software 40 belongs.

In addition, when the control software 40 set in the passive mode up to that time is switched to the active mode by the aforementioned failover function, unused control software 40 in any storage node 3, other than the storage node 3 provided with the control software 40 and the storage node 3 provided with the control software 40 of the original active mode, is activated in the passive mode and is set in a new redundancy group 44 together with the control software 40 switched to the active mode.

Furthermore, the configuration information 41 retained by the control software 40 switched to the active mode is transmitted to control software 40 of a new passive mode via the backend network 5, and the corresponding destination of the virtual volume VVOL correlated with the original redundancy group 44 is switched to the new redundancy group 44. In this way, the configuration of the original redundancy group 44 is reproduced in new original redundancy group 44.

The cluster control unit 42 is a program having a function of transmitting an I/O request sent from the compute node 2 to a cluster control unit 42 of a corresponding storage node 3 via the backend network 5, or taking over an I/O request, which is transmitted from another cluster control unit 42 via the backend network 5, to control software 40 of a redundancy group 44 correlated with a virtual volume VVOL that is a target of the I/O request.

Then, out of the two types of control software 40 having received the I/O request or having taken over the I/O request from the cluster control unit 42, the control software 40 set in the active mode performs processing according to the I/O request. For example, when the I/O request is a write request, the control software 40 dynamically allocates any physical page to a logical page designated in the I/O request in a virtual volume VVOL designated in the I/O request, and then writes data in the physical page. Furthermore, when the I/O request is a read request, the control software 40 reads data from a physical page allocated to a logical page on a virtual volume VVOL designated as a data read destination in the I/O request, and transmits the read data to the compute node 2 which is a transmission source of the I/O request.

As a means for performing such a process, the cluster control unit 42 stores configuration information (hereinafter, referred to as system configuration information) for each redundancy group 44 corresponding to each virtual volume VVOL in the system configuration information table 43 for the purpose of management, the system configuration information indicating control software 40 constituting a redundancy group 44 (FIG. 9), to which each virtual volume VVOL generated in the cluster 6 correlates, and a storage node 3 provided with the control software 40.

Furthermore, in the present embodiment, as a means for allowing the cluster control unit 42 of each storage node 3 in the same cluster 6 to always retain the system configuration information table 43 having the same content, one cluster control unit 42 is selected from the cluster control units 42 respectively installed in the storage nodes 3 constituting the cluster 6 as a representative cluster control unit 42 by a predetermined method.

The representative cluster control unit 42 regularly collects necessary information from the cluster control units 42 of other storage nodes 3, updates the system configuration information table 43, which is managed by the representative cluster control unit 42, on the basis of the collected information when necessary, and transmits the collected information to the cluster control unit 42 of each storage node 3 in the cluster 6. Thus, each cluster control unit 42 having received the information updates the system configuration information table 43 managed by the cluster control unit 42 to the latest state.

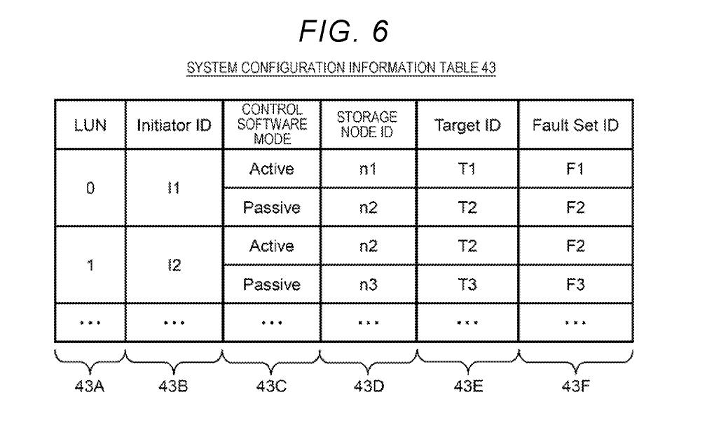

A configuration example of the system configuration information table 43 is illustrated in FIG. 6. As apparent from FIG. 6, the system configuration information table 43 includes a LUN column 43A, an initiator ID column 43B, a control software mode column 43C, a storage node ID column 43D, a target ID column 43E, and a fault set ID column 43F.

The LUN column 43A stores LUNs of virtual volumes VVOL respectively assigned to the virtual volumes VVOL generated in respective storage nodes 3 of the cluster 6, and the initiator ID column 43B stores identifiers (initiator IDs) of initiators IT (FIG. 9) permitted to access a corresponding virtual volume VVOL.

Furthermore, the control software mode column 43C, the storage node ID column 43D, the target ID column 43E, and the fault set ID column 43F are respectively classified in correlation with the mode (the active mode or the passive mode) of each control software 40 constituting the redundancy group 44 correlated with the corresponding virtual volume VVOL.

Each column classified in the control software mode column 43C stores the name (the active mode or the passive mode) of the mode of each control software 40, and each column classified in the storage node ID column 43D stores a storage node 3-specific identifier (a storage node ID) assigned to a storage node 3 provided with control software 40 of a corresponding mode.

Furthermore, each column classified in the target ID column 43E stores an identifier (a target ID) of a target TG (FIG. 9) defined in a corresponding storage node 3 and associated with the corresponding virtual volume VVOL.

Moreover, each column classified in the fault set ID column 43F stores a fault set-specific identifier (a fault set ID) assigned to a fault set to which the corresponding storage node 3 belongs. The “fault set” indicates a group of storage nodes 3 that share a power supply system or a network switch. Each control software 40 constituting the redundancy group 44 selects each arrangement destination of control software 40 to operate on storage nodes 3 belonging to different fault sets, so that it is possible to construct a redundancy group 44 with higher fault tolerance.

### (3) PATH MANAGEMENT FUNCTION

In the information processing system 1 of the present embodiment having such a configuration, when a failure occurs in the control software 40 set in the active mode in the redundancy group 44 as described above, the control software 40 set in the passive mode up to that time in the redundancy group 44 is switched to the active mode.

In such a case, among paths from the compute node 2 to the virtual volume VVOL, a path PS, which is connected to the storage node 3 provided with control software 40 (that is, the control software 40 of the active mode between two types of control software 40 constituting the redundancy group 44 correlated with the virtual volume VVOL) that actually processes an I/O request for the virtual volume VVOL, is the shortest path.

Accordingly, when the control software 40 of the passive mode in the redundancy group 44 is switched to the active mode due to a failure or the like of the control software 40 of the active mode in the redundancy group 44 as described above, a path to the virtual volume VVOL is also preferably switched to the path PS connected to the storage node 3 provided with the control software 40 switched to the active mode.

However, in a case where existing multipath software is used as the multipath software 31 (FIG. 4), it is not possible to automatically perform such path switching, and when the control software 40 of the passive mode is switched to the active mode, there is a problem that response performance of the cluster from the viewpoint of the compute node 2 is reduced.

Furthermore, in the existing multipath software, when the number of paths PS to the virtual volume VVOL is reduced, there is a problem that it is not possible to automatically increase the number of paths.

In this regard, when the multipath software 31 sets multipath to the virtual volume VVOL, the compute node 2 of the present embodiment has a function (hereinafter, referred to as a path management function) of setting a path PS, which is connected to a storage node 3 provided with control software 40 set in the active mode in a redundancy group 44 correlated with the virtual volume VVOL, as a path with the highest priority (hereinafter, referred to as a first priority path), and setting a path PS to a storage node 3 provided with control software 40 set in the passive mode in the redundancy group 44 as a path with the second highest priority (hereinafter, referred to as a second priority path).

Then, when an I/O request for the virtual volume VVOL is received from the application 30 (FIG. 4), the multipath software 31 transmits the I/O request to a corresponding storage node 3 via a path PS with the highest priority available at that time among a plurality paths PS set in the virtual volume VVOL.

In this way, in the present information processing system 1, even when a failure occurs in the control software 40 set in the active mode in the redundancy group 44, and the like and thus the control software 40 set in the passive mode up to that time in the redundancy group 44 is switched to the active mode, the compute node 2 can access the virtual volume VVOL correlated with the redundancy group 44 via the shortest path after the switching.

As a means for performing such a path management function, the memory 12 of the compute node 2 stores the multipath setting program 32 and the multipath configuration information table in addition to the aforementioned application 30 and multipath software 31 as illustrated in FIG. 4.

The multipath setting program 32 is a program having a function of, for example, when a new virtual volume VVOL is generated in the cluster 6, acquiring configuration information of a redundancy group 44 correlated with the virtual volume VVOL, and establishing a configuration (an initiator ID and a target ID of an initiator IT and a target TG to which each path PS is connected, a path priority of each path PS, and the like) of multipath MPS (FIG. 9) to the virtual volume VVOL or establishing a new configuration of multipath MPS (hereinafter, the configuration of the multipath MPS will be referred to as a multipath configuration) corresponding to a change in a configuration of any redundancy group 44 in the cluster 6.

Actually, as illustrated in FIG. 9, the multipath setting program 32 regularly inquires of a cluster control unit (for example, a representative cluster control unit) 42 in any storage node 3 constituting the cluster 6 about the configuration of the redundancy group 44 correlated with each virtual volume VVOL (S1).

Then, the cluster control unit 42 received the query reads the configuration information of the redundancy group 44 from the system configuration information table 43 retained in its own storage node 3 and returns the configuration information to the multipath setting program 32 that is an inquirer (S2).

Furthermore, on the basis of the configuration information of the redundancy group 44 acquired as above, the multipath setting program 32 decides, as the first priority path, a path PS to the storage node 3 provided with the control software 40 set in the active mode in the redundancy group 44 correlated with the virtual volume VVOL, and decides, as the second priority path, a path PS to the storage node 3 provided with the control software 40 set in the passive mode in the redundancy group 44.

Moreover, for example, in a case where there is a margin in the number of configurable paths such as a case where the number of paths for one virtual volume VVOL is smaller than the maximum number of paths supportable by the multipath software 31, the multipath setting program 32 decides a redundant path in addition to the first priority path and the second priority path. In such a case, the multipath setting program 32 selects one path PS from paths PS connected to a storage node 3 belonging to a fault set including neither the storage node 3 provided with the control software 40 set in the active mode in the redundancy group 44 correlated with the virtual volume VVOL nor the storage node 3 provided with the control software 40 set in the passive mode in the redundancy group 44, and decides the path PS as the redundant path.

After deciding the first priority path and the second priority path as described above and the redundant path when possible, the multipath setting program 32 registers necessary information related to the decided paths PS in the multipath configuration information table 33 as multipath configuration information in correlation with the virtual volume VVOL (S3).

Thus, on the basis of the multipath configuration information of the virtual volume VVOL registered in the multipath configuration information table 33, the multipath software 31 sets multipath MPS to the virtual volume VVOL (S4).

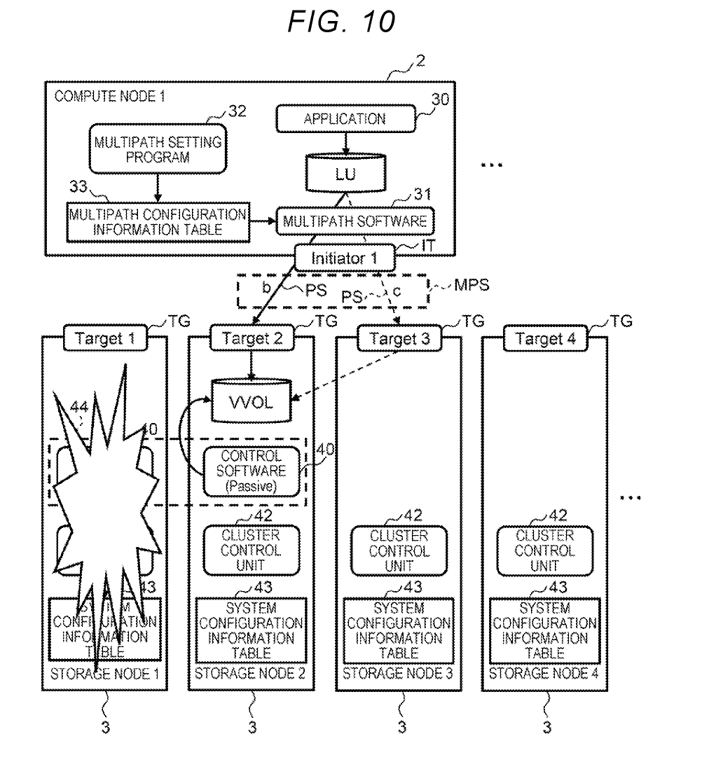

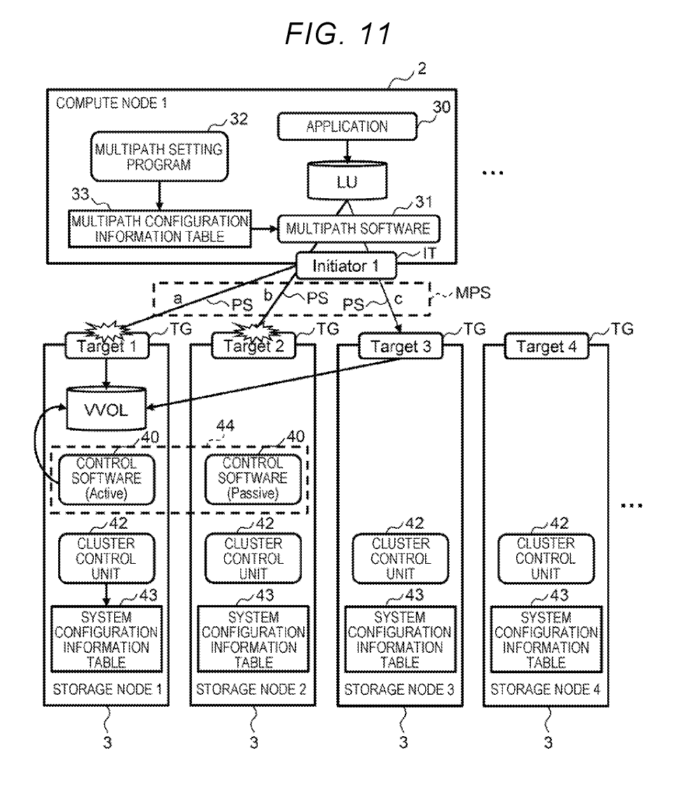

Thereafter, for example, in a case where a failure occurs in the control software 40 set in the active mode up to that time in the redundancy group 44 correlated with the virtual volume VVOL or the storage node 3 provided with the control software 40, the multipath software 31 switches a path to be used thereafter to a path (a second priority path) PS in which a path priority is set to a “second priority” as illustrated in FIG. 10, and in a case where the second priority path is also not available as illustrated in FIG. 11, the multipath software 31 switches a path to be used thereafter to a path (a redundant path) PS in which a path priority is set to a “redundant path”.

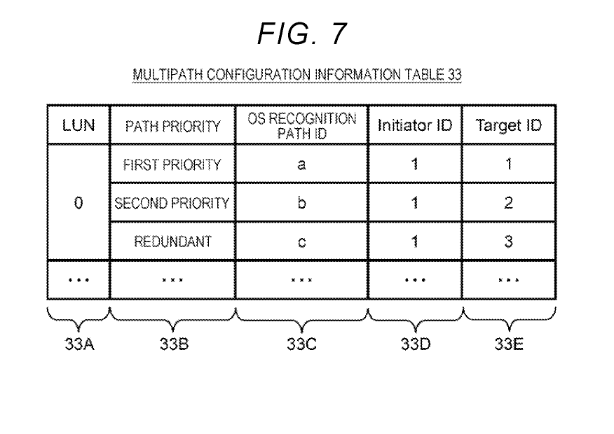

In addition, a configuration example of the multipath configuration information table 33 is illustrated in FIG. 7. As described above, the multipath configuration information table 33 is a table used in order to retain the configuration information of the multipath MPS (hereinafter, referred to as multipath configuration information) to each virtual volume VVOL established by the multipath setting program 32.

As illustrated in FIG. 7, the multipath configuration information table 33 includes a LUN column 33A, a path priority column 33B, an OS recognition path ID column 33C, an initiator ID column 33D, and a target ID column 33E. The LUN column 33A stores LUNs of virtual volumes VVOL set in the cluster 6.

Furthermore, the path priority column 33B, the OS recognition path ID column 33C, the initiator ID column 33D, and the target ID column 33E are respectively classified in correlation with each path constituting multipath set for a corresponding virtual volume VVOL.

Each column classified in the initiator ID column 33D stores an initiator ID of an initiator IT in its own computer node 2 to which a corresponding path PS is connected, and the target ID column 33E stores identifiers (target IDs) of targets TG, to which the corresponding path PS set by the multipath software 31 is connected, among targets TG defined for ports of respective storage node 3 in the cluster 6.

Furthermore, the OS recognition path ID column 33C stores identifiers (OS recognition path IDs) of corresponding paths PS, which are assigned to the paths PS and recognized by the OS of its own computer node 2, and the path priority column 33B stores path priorities of the corresponding paths PS, which are set for the paths PS.

Accordingly, the example of FIG. 7 indicates that a path PS, which connects between an initiator IT with an initiator ID of “1” and a target TG with a target ID of “1” and is recognized by a path ID with an OS of “a”, a path PS which connects between the initiator IT with the initiator ID of “1” and a target TG with a target ID of “2” and is recognized by a path ID with an OS of “b”, and a path PS which connects between the initiator IT with the initiator ID of “1” and a target TG with a target ID of “3” and is recognized by a path ID with an OS of “c” are present, as a path PS from a corresponding compute node 2 to a virtual volume having a LUN of “0”.

Furthermore, FIG. 7 indicates that the “first priority” is set as a path priority of a path with an OS recognition path ID of “a”, the “second priority” is set as a path priority of a path with an OS recognition path ID of “b”, and the “redundant” is set as a path priority of a path with an OS recognition path ID of “c”. In addition, the “first priority path” is the highest path priority and the “second priority path” is the second highest path priority. Furthermore, the “redundant” is the third highest path priority after the “second priority path”, and a path with the path priority of the “redundant” is used as a redundant path.

On the other hand, in the present information processing system 1, when the control software 40 set in the passive mode up to that time in the redundancy group 44 is switched to the active mode as described above, the configuration of the redundancy group 44 correlated with each virtual volume VVOL is appropriately changed, for example, a new control software 40 is activated in the passive mode and a new redundancy group is configured by the control software 40 switched to the active mode and the new control software 40 activated in the passive mode.

In this regard, the multipath setting program 32 monitors the configuration of each redundancy group 44 in the cluster 6 even after the multipath MPS is set for the virtual volume VVOL as described above. Specifically, similarly to the above, the multipath setting program 32 regularly inquires of any cluster control unit (for example, a representative cluster control unit) 42 in the cluster 6 about the configuration of each redundancy group 44. Then, when a change in the configuration of any redundancy group 44 is detected on the basis of a response from the cluster control unit 42 for such a query, the multipath setting program 32 updates the multipath configuration information table 33 according to the change.

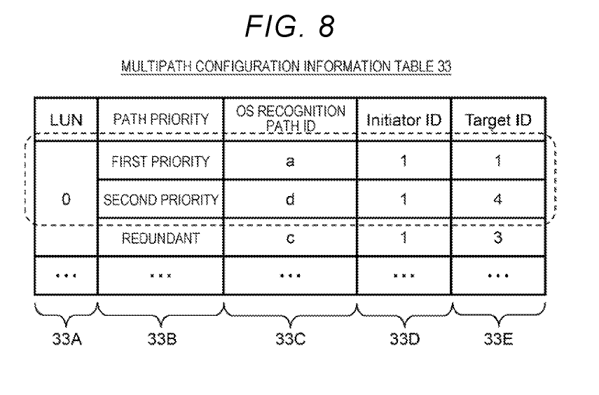

For example, in a case where the configuration of multipath MPS to the virtual volume VVOL with a LUN of “0” is in the state as illustrated in FIG. 7, a failure occurs in control software 40 set in the active mode in a redundancy group 44 correlated with the virtual volume VVOL or a storage node 3 provided with the control software 40, and if the multipath setting program 32 detects that control software 40 set in the passive mode up to that time is switched to the active mode, the configuration of multipath MPS to the virtual volume VVOL in the multipath configuration information table 33 is updated as illustrated in FIG. 8, for example.

As can be seen from the comparison of FIG. 7 and FIG. 8, in such a case, the path priority of a path (a second priority path) PS, in which a path priority has been set to a “second priority” up to that time, is changed to a “first priority”. Furthermore, FIG. 8 illustrates an example of setting a path PS that connects between the initiator IT with the initiator ID of “1” and a target TG with a target ID of “4” and is recognized by a path ID with an OS of “d”, as the second priority path.

### (4) VARIOUS PROCESSES RELATED TO PATH MANAGEMENT FUNCTION

Next, specific processing contents of various processes performed in association with the aforementioned path management function will be described.

### (4-1) Multipath Setting Process

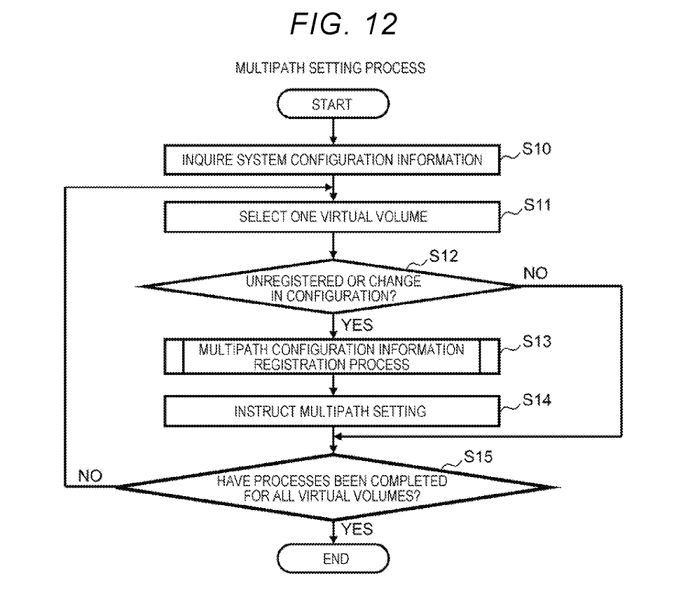

FIG. 12 illustrates a processing procedure of a multipath setting process regularly performed by the multipath setting program 32 of the compute node 2 in association with the path management function. The multipath setting program 32 establishes multipath MPS to a virtual volume VVOL, in which the multipath MPS existing in the cluster 6 has not been set, or a virtual volume VVOL for which the configuration of a corresponding redundancy group 44 has changed, or updates the configuration of the established multipath MPS, according to the processing procedure as illustrated in FIG. 12.

Actually, when the multipath setting process is started, the multipath setting program 32 firstly specifies initiator IDs of all initiators IT defined in its own compute node 2 with respect to a cluster control unit (for example, a representative cluster control unit) 42 (FIG. 5) in any storage node 3, and inquires system configuration information (configuration information of a redundancy group 44 correlated with the virtual volume VVOL in the system configuration information table 43) related to each virtual volume VVOL available by its own compute node 2 (S10).

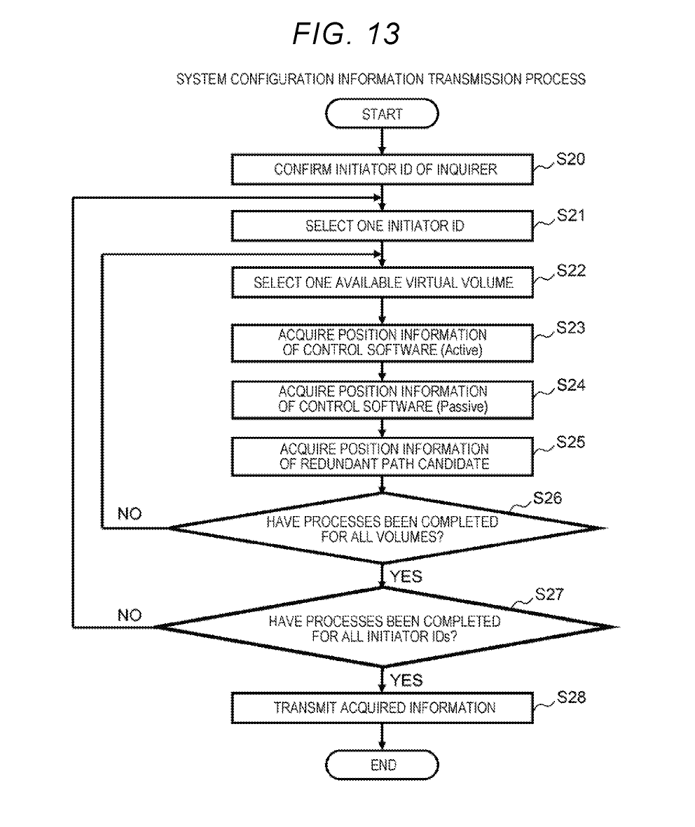

Thus, the cluster control unit 42 received the query reads the aforementioned system configuration information related to each virtual volume VVOL available by its own compute node 2 from the system configuration information table 43 and transmits the read system configuration information to the multipath setting program 32 as will be described later in FIG. 13.

Subsequently, on the basis of the system configuration information acquired in step S10, the multipath setting program 32 selects one virtual volume VVOL from the virtual volumes VVOL available by its own compute node 2 (S11). Hereinafter, this virtual volume VVOL will be referred to as a target virtual volume VVOL.

Next, the multipath setting program 32 determines whether there is any change in the configuration of a redundancy group 44 correlated with the target virtual volume VVOL such as absence of registration of multipath MPS to the target virtual volume VVOL in the multipath configuration information table 33 (FIG. 7) or a change in a storage node 3 in which control software of an active mode or a passive mode exists (S12). This determination is performed by comparing the system configuration information acquired in step S10 and associated with the target virtual volume VVOL with contents registered in the system configuration information table 43 (FIG. 6) or the multipath configuration information table 33 (FIG. 7) with respect to the target virtual volume VVOL.

In a case where a negative result is obtained in the determination of step S12, the multipath setting program 32 proceeds to step S15. Furthermore, in a case where a positive result is obtained in the determination of step S12, when multipath configuration information related to the multipath MPS to the target virtual volume VVOL has not been registered in the multipath configuration information table 33, the multipath setting program 32 newly registers the multipath configuration information in the multipath configuration information table 33. When the multipath configuration information to the target virtual volume VVOL has been registered in the multipath configuration information table 33, the multipath setting program 32 updates the multipath configuration information according to the current status (S13).

Furthermore, on the basis of the multipath configuration information related to the target virtual volume VVOL newly registered or updated in step S13, the multipath setting program 32 instructs the multipath software 31 (FIG. 4) to perform new setting or setting update of multipath MPS from an initiator IT associated with the target virtual volume VVOL in its own compute node 2 to the target virtual volume VVOL (S14).

Subsequently, on the basis of the system configuration information acquired in step S10, the multipath setting program 32 determines whether the processes of step S12 to step S14 are completely performed for all virtual volumes VVOL available by its own compute node 2 in the cluster 6 (S15). When a negative result is obtained in the determination, the multipath setting program 32 returns to step S11 and then repeats the processes of step S12 to step S15 while sequentially switching the target virtual volume VVOL selected in step S11 to other virtual volumes VVOL for which the processes of step S12 to step S14 have not been performed.

Then, the multipath setting program 32 completely performs the processes of step S12 to step S14 for all the virtual volumes VVOL available by its own compute node 2 in the cluster 6, and ends the multipath setting process when a positive result is obtained in step S15.

### (4-2) System Configuration Information Transmission Process

FIG. 13 illustrates a system configuration information transmission process performed by the cluster control unit (for example, the representative cluster control unit) 42 received the query from the multipath setting program 32 of the compute node 2 in step S10 of the aforementioned multipath setting process described in FIG. 12.

When the query is sent from the multipath setting program 32, the cluster control unit 42 starts the system configuration information transmission process illustrated in FIG. 13 and firstly confirms initiator IDs of all initiators IT defined in the compute node 2 of the inquirer (S20).

Subsequently, with reference to the system configuration information table 43 (FIG. 6), the cluster control unit 42 selects one initiator ID from the initiator IDs confirmed in step S20 (S21), detects all virtual volumes VVOL available from an initiator IT of the selected initiator ID, and selects one virtual volume VVOL from the detected virtual volumes VVOL (S22).

Specifically, the cluster control unit 42 selects one virtual volume VVOL from virtual volumes VVOL corresponding to a record of the initiator ID column 43B (FIG. 6), in which the initiator ID selected in step S21 is stored, among the records (rows) of the system configuration information table 43.

Next, as position information of control software 40 set in the active mode in a redundancy group 44 correlated with the virtual volume VVOL selected in step S22, the cluster control unit 42 acquires a storage node ID of a storage node 3 provided with the control software 40 and a target ID of a target TG correlated with the virtual volume VVOL (S23).

Specifically, with reference to the system configuration information table 43, the cluster control unit 42 specifies a record in which the LUN of the virtual volume VVOL selected in step S22 is stored in the LUN column 43A and “Active” is stored in the classified column of the control software mode column 43C, and acquires a storage node ID and a target ID respectively stored in the storage node ID column 43D (FIG. 6) and the target ID column 43E (FIG. 6) of the record.

Furthermore, as position information of control software 40 set in the passive mode in the redundancy group 44 correlated with the virtual volume VVOL selected in step S22, the cluster control unit 42 acquires a storage node ID of a storage node 3 provided with the control software 40 and a target ID of a target TG correlated with the virtual volume VVOL (S24).

Specifically, with reference to the system configuration information table 43, the cluster control unit 42 specifies a record in which the LUN of the virtual volume VVOL selected in step S22 is stored in the LUN column 43A and “Passive” is stored in the classified column of the control software mode column 43C, and acquires a storage node ID and a target ID respectively stored in the storage node ID column 43D (FIG. 6) and the target ID column 43E of the record.

Moreover, as position information of a target TG that can be a connection destination of a redundant path to the virtual volume VVOL selected in step S22, the cluster control unit 42 acquires a storage node ID of a storage node 3 in which the target TG is defined and a target ID of the target TG (S25).

Specifically, the cluster control unit 42, for example, selects one storage node 3 with the lowest load from storage nodes 3 that belong to neither a fault set with a fault set ID stored in the fault set ID column 43F (FIG. 6) of the record of the system configuration information table 43 specified in step S23 nor a fault set with a fault set ID stored in the fault set ID column 43F of the record of the system configuration information table 43 specified in step S24. Then, the cluster control unit 42 acquires a storage node ID of the selected storage node 3 and a target ID of the target TG defined in the storage node 3 from the system configuration information table 43.

Subsequently, the cluster control unit 42 determines whether the processes after step S22 is completely performed for all the virtual volumes VVOL available from the initiator IT selected in step S21 (S26).

When a negative result is obtained in the determination, the cluster control unit 42 returns to step S22 and then repeats the processes of step S22 to step S26 while sequentially switching the virtual volume VVOL selected in step S22 to virtual volumes VVOL for which the processes after step S23 have not been performed among the corresponding virtual volumes VVOL.

Soon after that, the cluster control unit 42 completely performs the processes after step S22 for all the virtual volumes VVOL available from the initiator IT selected in step S21, and determines whether the processes after step S22 is completely performed for all the initiator IDs confirmed in step S20 when a positive result is obtained in step S26 (S27).

When a negative result is obtained in the determination, the cluster control unit 42 returns to step S21 and then repeats the processes of step S21 to step S27 while sequentially switching the initiator ID selected in step S21 to initiator IDs for which the processes after step S22 have not been performed among the corresponding initiator IDs.

Soon after that, the cluster control unit 42 completely performs the processes after step S21 for all the initiator IDs confirmed in step S20, transmits all information obtained by the processes of step S20 to step S27 to the multipath setting program 32 (FIG. 4) of the compute node 2 of the inquirer when a positive result is obtained in step S27 (S28), and then ends the system configuration information transmission process.

### (4-3) Multipath Configuration Information Registration Process

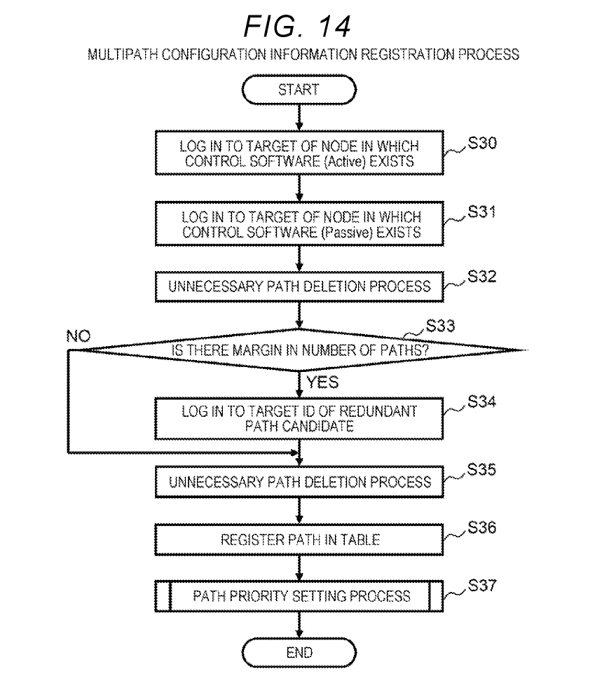

On the other hand, FIG. 14 illustrates processing contents of a multipath configuration information registration process performed by the multipath setting program 32 (FIG. 4) in step S13 of the aforementioned multipath setting process described in FIG. 12. The multipath setting program 32 registers the configuration information of the multipath MPS to the target virtual volume VVOL in the multipath configuration information table 33 (FIG. 7) according to the processing procedure as illustrated in FIG. 14.

Actually, when step S13 of the multipath setting process is performed, the multipath setting program 32 starts the multipath configuration information registration process as illustrated in FIG. 14 and firstly logs in to a target TG correlated with the target virtual volume VVOL among targets TG defined in the storage node 3 provided with the control software (hereinafter, referred to as target virtual volume VVOL-compatible active control software) 40 set in the active mode in the redundancy group 44 correlated with the target virtual volume VVOL, on the basis of the system configuration information acquired in step S10 of the multipath setting process (S30).

By this login, for all virtual volumes VVOL available via the target TG, necessary information related to paths PS (FIG. 9) to the virtual volumes VVOL is registered in a path list (not illustrated) in an initial state. The “necessary information” registered in the multipath configuration information table 33 is information other than the path priority stored in the path priority column 33B (FIG. 7) of the record of the multipath configuration information table 33. The same applies below. In addition, when the multipath setting program 32 has logged in to the target TG, the process of step S30 is skipped.

Subsequently, on the basis of the system configuration information acquired in step S10 of the multipath setting process, the multipath setting program 32 logs in to a target TG correlated with the target virtual volume VVOL among the targets TG defined in the storage node 3 provided with the control software (hereinafter, referred to as target virtual volume-compatible passive control software) 40 set in the passive mode in the redundancy group 44 correlated with the target virtual volume VVOL (S31).

By this login, for all the virtual volumes VVOL available via the target TG, necessary information related to paths PS to the virtual volumes VVOL is registered in the aforementioned path list. In addition, when the multipath setting program 32 has logged in to the target TG, the process of step S31 is skipped.

Next, the multipath setting program 32 deletes a path to virtual volumes VVOL, other than the target virtual volume VVOL, among the paths registered in the path list in step S30 and step S31 from the path list (S32). Then, the multipath setting program 32 determines whether there is a margin in the number of paths to the target virtual volume VVOL (S33).

When a negative result is obtained in the determination, the multipath setting program 32 proceeds to step S35. In contrast, when a positive result is obtained in the determination of step S33, on the basis of position information (see the description of step S25 of FIG. 13) of redundant path candidates acquired in step S10 of the multipath setting process (FIG. 12), the multipath setting program 32 logs in to a target TG corresponding to the redundant path setting candidates (S34).

By this login, necessary information related to paths PS to the all virtual volumes VVOL available via the target TG is registered in the aforementioned path list. In addition, when the multipath setting program 32 has logged in to the target TG, the process of step S34 is skipped.

Subsequently, the multipath setting program 32 deletes a path to virtual volumes VVOL, other than the target virtual volume VVOL, among the paths registered in the path list in step S34 from the path list (S35). As a consequence, by the processes of step S30 to step S35, information on the following three types of paths (PS1) to (PS3) in relation to the target virtual volume VVOL is registered in the path list.

(PS1) A path that connects the target TG, which is correlated with the target virtual volume VVOL among the targets TG defined in the storage node 3 in which the target virtual volume VVOL-compatible active control software 40 is operated, to a corresponding initiator IT of its own compute node 2.

(PS2) A path that connects the target TG, which is correlated with the target virtual volume VVOL among the targets TG defined in the storage node 3 in which the target virtual volume VVOL-compatible passive control software 40 is operated, to the corresponding initiator IT of its own compute node 2.

(PS3) A path of the redundant path candidate of which position information is acquired in step S25 of the system configuration information transmission process (FIG. 13).

Next, the multipath setting program 32 registers necessary information related to each path registered in the path list by the processes of step S30 to step S35 in the multipath configuration information table 33 (S36), sets path priorities in these paths (S37), then ends the multipath configuration information registration process, and returns to the multipath setting process (FIG. 12).

### (4-4) Path Priority Setting Process

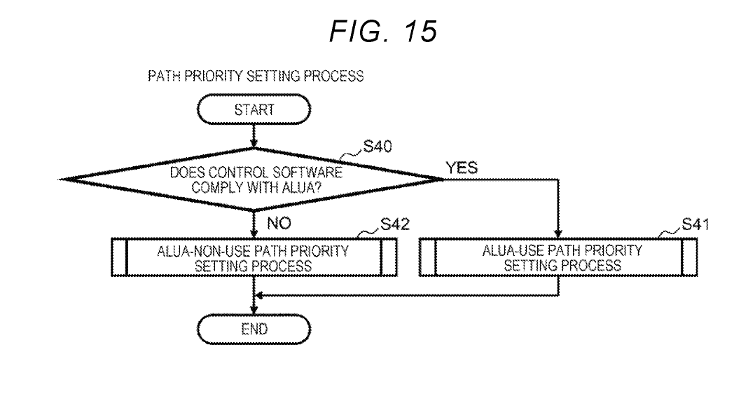

FIG. 15 illustrates processing contents of a path priority setting process performed by the multipath setting program 32 in step S37 of the aforementioned multipath configuration information registration process described in FIG. 14. The multipath setting program 32 registers the necessary information, which is related to each path registered in the aforementioned path list, in the multipath configuration information table 33 (FIG. 7) according to the processing procedure as illustrated in FIG. 15, and sets path priorities in these paths.

Actually, the multipath setting program 32 determines whether each control software 40 of the storage node 3 complies with the asymmetric logical unit access (ALUA) standard of the small computer system interface (SCSI) (S40). This determination is performed based on responses obtained after the multipath setting program 32 is inquired of corresponding control software 40 of each storage node 3.

When a positive result is obtained in the determination, the multipath setting program 32 decides the path priorities of each path PS (FIG. 9), of which necessary information is registered in the multipath configuration information table 33 in the process of step S36 of the immediately previous multipath configuration information registration process (FIG. 14), as path priorities according to the state of the ALUA of the paths PS in cooperation with the multipath software 31 (FIG. 4) in its own compute node 2, and registers the decided path priorities of these paths PS in the path priority column 33B (FIG. 7) that is a corresponding entry of the multipath configuration information table 33 (S41). Then, the multipath setting program 32 ends the path priority setting process and returns to the multipath configuration information registration process (FIG. 14).

In contrast, when a negative result is obtained in the determination of step S40, the multipath setting program 32 respectively sets path priorities according to an arrangement position of each control software 40, which constitutes the redundancy group 44 correlated with the target virtual volume VVOL, in each path PS of which necessary information is registered in the multipath configuration information table 33 in the process of step S36 of the immediately previous multipath configuration information registration process (FIG. 14) (S42). Then, the multipath setting program 32 ends the path priority setting process and returns to the multipath configuration information registration process (FIG. 14).

### (4-5) ALUA-Use Path Priority Setting Process

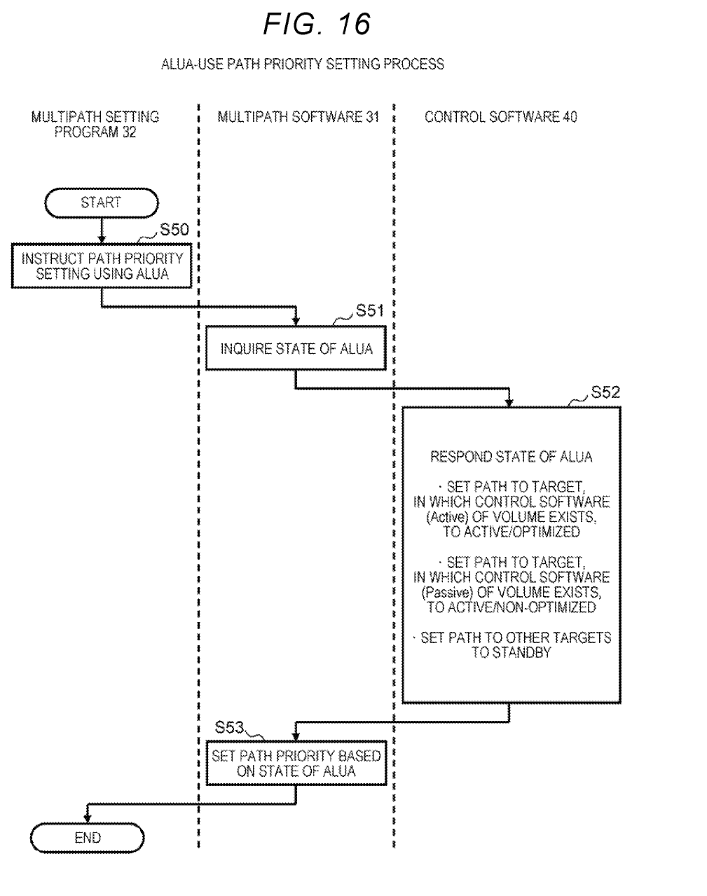

FIG. 16 illustrates detailed processing contents of the process (hereinafter, referred to as an ALUA-use path priority setting process) performed by the multipath setting program 32 in step S41 of the aforementioned path priority setting process described in FIG. 15.

When step S41 of the path priority setting process is performed, the multipath setting program 32 starts the ALUA-use path priority setting process as illustrated in FIG. 16 and firstly instructs the multipath software 31 to set the priorities according to the state of the ALUA in each path registered in the aforementioned path list by the aforementioned multipath configuration information registration process described in FIG. 14 (S50).

The multipath software 31 received the instruction transmits a Report Target Port Groups command to each control software 40, which constitutes the redundancy group 44 correlated with the target virtual volume VVOL, and control software 40, which is connected to a target TG connected to the redundant path PS in a storage node 3, via the storage service network 4, thereby inquiring the state of the ALUA of a corresponding path PS (S51).

Thus, when the Report Target Port Groups command is received, the control software 40 set in the active mode in the redundancy group 44 correlated with the target virtual volume VVOL returns “Active/Optimized” as the state of the ALUA of a corresponding path (a path that connects an initiator IT of a corresponding compute node 2 to the target TG correlated with the target virtual volume VVOL in the storage node 3 provided with the control software 40) PS, the “Active/Optimized” indicating that the path PS is a path from which the best performance is obtained and redirect at a higher level is not necessary in order to complete I/O.

In contrast, when the Report Target Port Groups command is received, the control software 40 set in the passive mode in the redundancy group 44 correlated with the target virtual volume VVOL returns “Active/Non-optimized” as the state of the ALUA of the corresponding path PS, the “Active/Non-optimized” indicating that the redirect at a higher level is necessary in order to complete the I/O.

Furthermore, the control software 40 received the Report Target Port Groups command of the storage node 3 connected to the redundant path PS returns “Standby” as the state of the ALUA of the redundant path PS, the “Standby” indicating that it is not supported.

Then, on the basis of responses from these types of control software 40, the multipath software 31 sets path priorities in each path PS, which is registered in the multipath configuration information table 33 (FIG. 7) by the aforementioned multipath configuration information registration process described in FIG. 14, in accordance with the state of the ALUA of each path PS (S53).

Specifically, in order to set the highest path priority in a path PS passing through the storage node 3 provided with the control software 40 set in the active mode in the redundancy group 44 correlated with the target virtual volume VVOL, the multipath software 31 stores a “first priority” in the path priority column 33B of a corresponding record (a record in which the initiator ID of the initiator IT of its own compute node 2 is registered in the initiator ID column 33D and the target ID of a corresponding target TG defined in the storage node 3 is stored in the target ID column 33E) of the multipath configuration information table 33, the “first priority” indicating that the path PS is a first priority path.

Furthermore, in order to set the second highest path priority in a path PS passing through the storage node 3 provided with the control software 40 set in the passive mode in the redundancy group 44 correlated with the target virtual volume VVOL, the multipath software 31 stores a “second priority” in the path priority column 33B of a corresponding record of the multipath configuration information table 33, the “second priority” indicating that the path PS is a second priority path.

Moreover, in order to set the third highest path priority in the redundant path PS, the multipath software 31 stores a “redundant” in the path priority column 33B of a corresponding record of the multipath configuration information table 33, the “redundant” indicating that the path PS is a redundant path.

When the multipath software 31 finishes the setting of the path priority of each path PS as described above, the multipath setting program 32 ends the ALUA-use path priority setting process and returns to the path priority setting process (FIG. 15).

### (4-6) ALUA-Non-Use Path Priority Setting Process

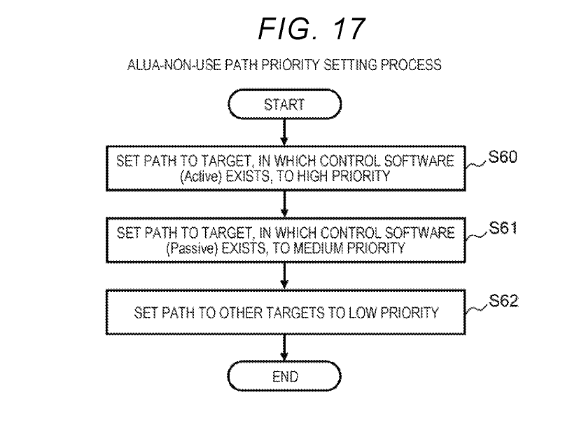

FIG. 17 illustrates detailed processing contents of the process (hereinafter, referred to as an ALUA-non-use path priority setting process) performed by the multipath setting program 32 in step S42 of the aforementioned path priority setting process described in FIG. 15.

When step S42 of the path priority setting process is performed, the multipath setting program 32 starts the ALUA-non-use path priority setting process as illustrated in FIG. 17 and firstly sets the highest path priority in a path PS to the corresponding target TG defined in the storage node 3 provided with the control software 40 set in the active mode among the control software 40 constituting the redundancy group 44 correlated with the target virtual volume VVOL (S60).

Specifically, the multipath setting program 32 stores a “first priority” in the path priority column 33B of a corresponding record (a record in which the initiator ID of the initiator IT of its own compute node 2 is registered in the initiator ID column 33D and the target ID of the corresponding target TG defined in the storage node 3 is stored in the target ID column 33E) of the multipath configuration information table 33.

Furthermore, the multipath setting program 32 sets the second highest path priority in a path PS to the corresponding target TG defined in the storage node 3 provided with the control software 40 set in the passive mode among the control software 40 constituting the redundancy group 44 correlated with the target virtual volume VVOL (S61). Specifically, the multipath setting program 32 stores a “second priority” in the path priority column 33B of a corresponding record of the multipath configuration information table 33.

Moreover, the multipath setting program 32 stores a “redundant” in the path priority column 33B of a record of the multipath configuration information table 33, which corresponds to a path PS selected as a redundant path at that time.

Then, the multipath setting program 32 ends the ALUA-non-use path priority setting process and returns to the path priority setting process.

### (5) EFFECTS OF PRESENT EMBODIMENT

As described above, in the information processing system 1 of the present embodiment, when setting the multipath MPS to the virtual volume VVOL, a path PS connected to the target TG corresponding to the storage node 3 provided with the control software 40 set in the active mode in the redundancy group 44 correlated with the virtual volume VVOL is set as the first priority path, and a path PS connected to the target TG corresponding to the storage node 3 provided with the control software 40 set in the passive mode in the redundancy group 44 is set as the second priority path.

Accordingly, even when a failure occurs in the control software 40 set in the active mode in the redundancy group 44 or the storage node 3 provided with the control software 40 and thus the control software 40 set in the passive mode in the redundancy group 44 is switched to the active mode, the compute node 2 can access the virtual volume VVOL via the shortest path PS at that time.

Thus, even when such mode switching (switching of the control software 40 constituting the redundancy group 44 to the active mode from the passive mode) occurs in the redundancy group 44, it is possible to effectively prevent the response performance of the cluster 6 from the viewpoint of the compute node 2 from being reduced in advance, and to set multipath MPS with high fault tolerance.

Furthermore, in the present information processing system 1, since a path PS is set for only a target TG required from one compute node 2, the number of unnecessary packets continuously flowing through an unused path PS is small even when a communication standard used in a path is, for example, the iSCSI, so that it is also possible, correspondingly, to minimize consumption of a network band of the storage service network 4 by the packets.

### (6) OTHER EMBODIMENTS

In the aforementioned embodiment, a case where the invention is applied to the information processing system 1 configured as illustrated in FIG. 1 has been described; however, the invention is not limited thereto and can be widely applied to information processing systems having other configurations.

Furthermore, in the aforementioned embodiment, a case wherein the storage node 3, a control unit (the control software 40) for processing an I/O request from the compute node 2 is configured by software has been described; however, the invention is not limited thereto and the control unit may be configured by hardware.

The invention, for example, can be applied to an information processing system including a plurality of storage nodes installed with one or a plurality of SDSs.

What is claimed is:

1. An information processing system comprising:
one or a plurality of storage nodes each provided with one or a plurality of storage devices; and
one or a plurality of compute nodes that read and write data from and to the storage nodes, wherein
each storage node is provided with one or a plurality of control units,
a plurality of control units provided in the different storage nodes are managed as redundancy groups and one or a plurality of volumes, to which a storage area is provided from the storage device, are correlated with the redundancy groups,
some of the control units constituting the redundancy group are set in an active mode in which the request from the compute node is received and remaining control units constituting the redundancy group are set in a passive mode in which the request is not received,
the control unit set in the active mode reads and writes data from and to the volume in accordance with the request from the compute node, which targets the volume correlated with the redundancy group including the control unit, and the control unit set in the passive mode is switched to the active mode when the control unit set in the active mode is not able to process the request from the compute node, and
the compute node inquires of the storage node about a configuration of each redundancy group,
sets a plurality of paths from the compute node to the volume on the basis of the acquired configuration of each redundancy group,
sets a priority in each path,
transmits the request for the volume to a corresponding storage node by using an available path with a highest priority among the paths to the corresponding volume, and
sets a highest priority in a path connected to the storage node provided with the control unit of the active mode, which constitutes the redundancy group correlated with the volume, while setting a second highest priority in a path connected to the storage node provided with the control unit of the passive mode, which constitutes the redundancy group, when setting the plurality of paths from the compute node to the volume.

2. The information processing system according to claim 1, wherein
when there is a margin in the number of paths from the compute node to the volume, the compute node sets a path, which passes through a storage node not provided with any of the control units constituting the redundancy group correlated with the volume, as a redundant path.

3. The information processing system according to claim 2, wherein
the compute node manages a fault set to which each storage node belongs, and
sets, as the redundant path, a path passing through the storage node, which is not provided with any of the control units constituting the corresponding redundancy group and belongs to a fault set different from the fault set including each storage node provided with one control unit constituting the redundancy group, when setting the redundant path.

4. The information processing system according to claim 3, wherein
when the compute node complies with a protocol for specifying an optimized path between the compute node and the storage node, the compute node sets a priority of each path to the corresponding volume in accordance with a state of the protocol.

5. A path management method performed in an information processing system, wherein
the information processing system includes one or a plurality of storage nodes each provided with one or a plurality of storage devices, and one or a plurality of compute nodes that read and write data from and to the storage nodes,
each storage node is provided with one or a plurality of control units,
a plurality of control units provided in the different storage nodes are managed as redundancy groups and one or a plurality of volumes, to which a storage area is provided from the storage device, are correlated with the redundancy groups,
some of the control units constituting the redundancy group are set in an active mode in which the request from the compute node is received and remaining control units constituting the redundancy group are set in a passive mode in which the request is not received, and
the control unit set in the active mode reads and writes data from and to the volume in accordance with the request from the compute node, which targets the volume correlated with the redundancy group including the control unit, and the control unit set in the passive mode is switched to the active mode when the control unit set in the active mode is not able to process the request from the compute node,
the path management method comprising:
a first step in which the compute node inquires of the storage node about a configuration of each redundancy group, sets a plurality of paths from the compute node to the volume on the basis of the acquired configuration of each redundancy group, and sets a priority in each path; and
a second step in which the compute node transmits the request for the volume to a corresponding storage node by using an available path with a highest priority among the paths to the corresponding volume, wherein
in the first step, the compute node sets a highest priority in a path connected to the storage node provided with the control unit of the active mode, which constitutes the redundancy group correlated with the volume, while setting a second highest priority in a path connected to the storage node provided with the control unit of the passive mode, which constitutes the redundancy group, when setting the plurality of paths from the compute node to the volume.

6. The path management method according to claim 5, wherein
in the first step, when there is a margin in the number of paths from the compute node to the volume, the compute node sets a path, which passes through a storage node not provided with any of the control units constituting the redundancy group correlated with the volume, as a redundant path.

7. The path management method according to claim 6, wherein
the compute node manages a fault set to which each storage node belongs, and
in the first step, the compute node sets, as the redundant path, a path passing through the storage node, which is not provided with any of the control units constituting the corresponding redundancy group and belongs to a fault set different from the fault set including each storage node provided with one control unit constituting the redundancy group, when setting the redundant path.

8. The path management method according to claim 7, wherein
in the first step, when the compute node complies with a protocol for specifying an optimized path between the compute node and the storage node, the compute node sets a priority of each path to the corresponding volume in accordance with a state of the protocol.
